(19) United States
(12) Patent Application Publication
(10) Pub. No.: US 2023/0306918 A1
(43) Pub. Date: Sep. 28, 2023

(54) DEVICE FOR DISPLAYING INFORMATION, IN PARTICULAR FOR A VEHICLE

(71) Applicant: BEHR-HELLA THERMOCONTROL GMBH, Lippstadt (DE)

(72) Inventors: Tuomas SIEKKINEN, Tampere (FI); Remi BERGMANN, Tampere (FI)

(21) Appl. No.: 18/018,917

(22) PCT Filed: Aug. 5, 2021
(86) PCT No.: PCT/EP2021/071893

§ 371 Date: Jan. 31, 2023

(30) Foreign Application Priority Data
Aug. 5, 2020 (DE) 10 2020 120 599.6

(51) Int. Cl. G09G 3/34; G06F 3/041; G09G 3/36; G02F 1/137; F21V 8/00; G02F 1/1347; G02F 1/13357

(52) U.S. Cl. CPC G09G 3/3426; G02B 6/0068; G02F 1/133605; G02F 1/13478; G02F 1/137; G06F 3/041; G09G 3/36; G02F 1/13338; G02F 2203/09; G02F 2203/48; G09G 2320/0626

(57) ABSTRACT

The device for displaying information, in particular for a vehicle, is provided with a display unit having a plurality of pixels and having a front side forming the display surface for displaying information and a rear side facing away from the front side. Furthermore, the device comprises a backlighting unit for emitting backlight towards the rear side of the display unit for backlighting the same, and an adjustable transreflective layer between the backlighting unit and the display unit. The adjustable transreflective layer has an array of segments, each of which is controllable by means of an electric control signal to adjust the degree of transmission and/or reflection and is thus dimmable. The contrast of information shown on the display surface can be adjusted by dimming, as a result of controlling the segments, those pixels of the display unit which are arranged in alignment with the segment or segments concerned and are assigned to the same.

The invention relates to a device for displaying information, primarily for use in a vehicle. The information to be displayed is typically alphanumeric information or graphic information such as symbols.

It is known that depending on the strength of the ambient light electronic display devices have to be adjusted with regard to the contrast of the displayed information, i.e. with regard to the “light-dark difference” of the displayed information, so that the displayed information can still be easily recognized. This requirement particularly plays an important role in vehicles, as the driver must be able to reliably recognize the information well. In a vehicle in particular, the requirements for rapid changes in contrast are also high since the lighting conditions in the vehicle compartment can fluctuate rapidly and strongly when travelling due to changes in the environment.

In prior art, the change in contrast in electronic display devices is achieved in electronic display devices with non-actively illuminated pixels by locally dimming the backlight of the display device in certain areas. For this purpose, the backlight is locally attenuated by material layers that usually absorb the light radiation and whose degree of absorption can be controlled. This approach is energetically disadvantageous and also leads to a not inconsiderable heating of the said layer when it absorbs radiation, even if only locally, so that the pixels penetrated by this radiation are illuminated more weakly.

From US-A-2014/0293188 (corresponds to KR-A-102015123915), an electronic display device is known in which a shutter module is used to locally dim the display device. A similar application in a transflective LCD display is known from EP-A-1 666 961. Various approaches to the design of backlighting units for display units in particular are known from JP-A-2019-095559 and WO-A-2019/197525.

It is an object of the invention to provide a device for displaying information, in particular for a vehicle, which is improved in the above-mentioned respect.

The object of the invention is achieved with the invention proposing a device for displaying information, in particular for a vehicle, provided with
a display unit having a plurality of pixels,
the display unit having a front side forming the display surface for displaying information and a rear side facing away from the front side,
a backlighting unit for emitting backlight towards the rear side of the display unit for backlighting the same, and
an adjustable transreflective layer (sometimes referred to as transflective in the literature) between the backlighting unit and the display unit for transmitting backlight to backlight the display unit and/or for reflecting backlight to the backlighting unit,
the adjustable transreflective layer having an array of segments, each of which is controllable by means of an electric control signal to adjust the degree of transmission and/or reflection and is thus dimmable, and
wherein the contrast of information shown on the display surface can be adjusted by dimming, as a result of controlling the segments, of those pixels of the display unit which are arranged in alignment with the segment or segments concerned and are assigned to the same.

According to the invention, it is provided to use an electronically adjustable transreflective layer for local attenuation of the backlight of an electronic display device with passive pixels, the reflection degree as well as the transmission degree of which is electronically or electrically adjustable, wherein settings can also be selected at which partial transmission and partial reflection of backlight occurs. Such a transreflective layer is preferably the adjustable mirror layer with liquid crystal technology (also known as LC mirror), which is known per se. This technology makes it possible to give the liquid crystal layer properties like a mirror coating, wherein the degree of reflection and thus the degree of transmission can be adjusted electronically/electrically. Examples for the design and fabrication as well as functionality of such LC mirror layers are described in US-A-6 674 504 and in the conference paper: P. Lemarchand, J. Doran, B. Norton, “Investigation of Liquid Crystal Switchable Mirror Optical Characteristics for Solar Energy”, CISBAT 2013, September 4-6, 2013, Lausanne, Switzerland, and in many of the literatures cited in this conference paper.

Alternative configurations of the adjustable transreflective layer that can be used according to the invention are so-called reversible electrochromic or electrochemical mirror (REM) layers. Various designs and manufacturing methods of such mirror layers as well as the functionalities of SEM mirror layers are described in US-B-9 383 619, US-B-6 721 080, WO-A-01/06312, WO-A-02/23259, WO-A-02/06884, WO-A-2018/186603, and in “Switchable silver mirrors with long memory effects,” Chijuyun Park, Seogjae Seo, Haijin Shin, Bhimrao D. Sarwade, Jongbeoum Na, and Eunkyoung Kim, Chemical Science, 2015, 6, 596 (DOI: 10.1039/c4sc01912a).

For local dimming of individual pixel areas of the display device, the reflection degree of the adjustable mirror layer is thus increased, which has the advantage that the reflected light, after reflection at or in the backlighting unit, is reflected back in the direction of the display device in order to then transilluminate, or penetrate, such pixels that are to be dimmed to a lesser extent or not at all. This means that the light reflected at the mirror layer for dimming the pixels assigned to a segment of the mirror layer can return to the backlighting unit to be reflected again from there in the direction of neighboring segments whose assigned pixels do not need to be dimmed as much or at all, thus increasing the luminous efficiency or light energy efficiency of the entire device.

In this respect, it may be considered an advantageous further development of the invention that the backlighting unit comprises an array of reflectors and a plurality of light sources, wherein at least one light source is assigned to each reflector, and that at least one segment of the adjustable transreflective layer and preferably more than one segment, for example two to ten segments of the adjustable transreflective layer are arranged in alignment with each reflector. Each reflector is assigned at least one light source and at least one segment of the adjustable mirror layer. It is expedient if a plurality of segments, for example two or four or even more segments, are assigned to each reflector. The above-described advantage of the improved luminous efficiency can now be used if not all segments of the controllable mirror layer assigned to a reflector have to be dimmed. However, if this were the case, it would be possible to increase energy efficiency, for example, by selectively reducing the intensity of the light emitted by the at least one light source assigned to said reflector.

However, the advantage of the invention can also be used in another configuration of the backlighting unit. Such an alternative configuration may be characterized, for example, in that the backlighting unit comprises a plurality of light sources and a light guide plate having two main surfaces and a side surface therebetween, one of the two main surfaces facing the back of the display unit and being provided for emitting light entering the light guide plate from the side surface or light entering the light guide plate from the other main surface. The light reflected towards the light exit side of the light guide plate can be reflected back from the latter to the mirror layer, which can then penetrate an adjacent segment of the mirror layer that is to be dimmed to a lesser extent and thus also transilluminate the pixels assigned to this segment.

In a further advantageous configuration, it may be provided that the light sources are designed as LEDs or laser diodes and/or that the display surface of the device is given touch sensitivity by means of a touch panel, i.e. the display device according to the invention is a touch screen, for example.

The preferred technology to be used for the display device according to the invention relates to LCD technology, which makes it possible to manufacture display devices of a wide variety of sizes and shapes at low cost.

The invention is explained in more detail below by means of an exemplary embodiment and with reference to the drawing. In the Figures:

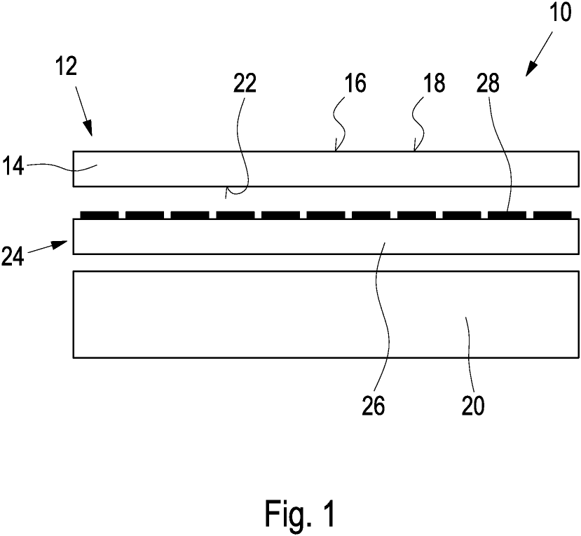

FIG. 1 is a schematic view of the main components of an exemplary embodiment of an electronic device for displaying information according to the invention,

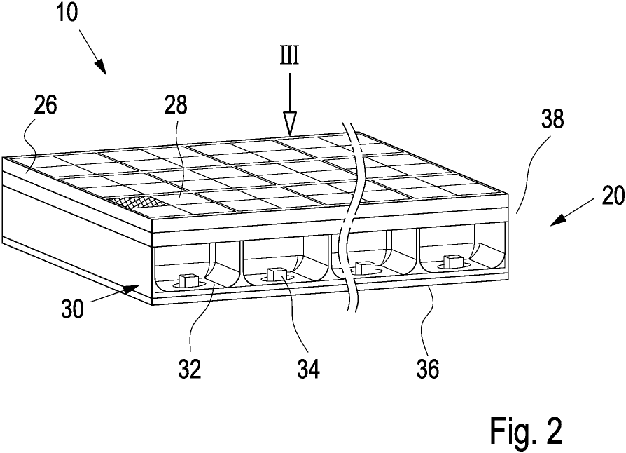

FIG. 2 is a perspective and partially broken-down view of the backlighting unit with individual reflectors and a diffuser arranged above them, as well as a controllable LC mirror layer above the diffuser with groups of four segments assigned to the individual reflectors in this embodiment,

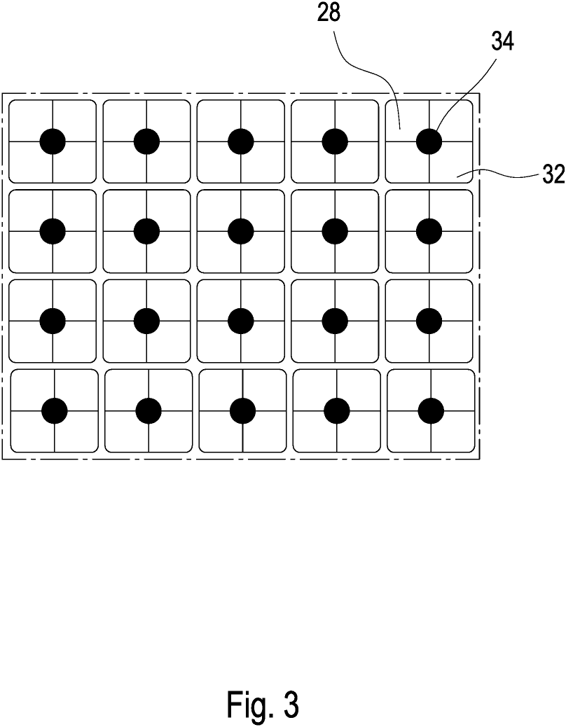

FIG. 3 is a plan view of the LC mirror layer (partially), and

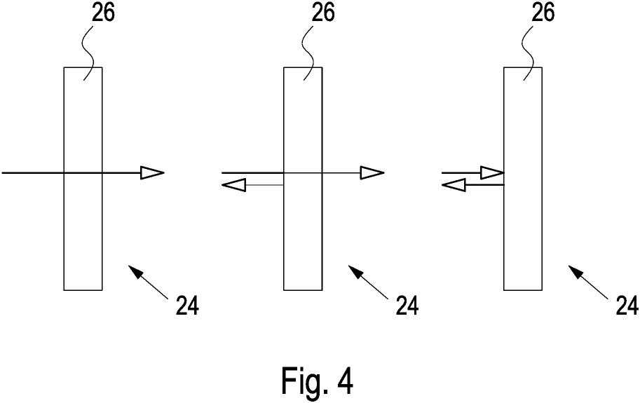

FIG. 4 is a schematic illustration of the different operating states in which the controllable LC mirror layer can be operated.

FIG. 1 is a schematic illustration of the main components of a device 10 for displaying graphic and/or alphanumeric information according to the invention. A component of said device 10 is a display unit 12, which in this exemplary embodiment is an LCD 14 (liquid crystal display). The front side 16 of the display device 12 forms the display surface 18, wherein in this illustration, the cover glass typically found on LCDs and the optical connection have been omitted. The display unit 12 can additionally be provided with a touch sensor system, which is also not shown in the schematic illustration of FIG. 1.

Below the display unit 12 is a backlighting unit 20, which will be discussed further below.

Between the backlighting unit 20 and the rear side 22 of the display unit 12 is a controllable transreflective layer 24, which in this exemplary embodiment is designed as an electronically controllable and thus adjustable LC mirror layer 26 (liquid crystal mirror layer) or as a reversible electrochromic or electrochemical mirror layer (REM mirror layer).

Referring to FIG. 4, it is clear how the transreflective LC layer 26 can be operated. By electronically driving the transreflective LC mirror layer 26, it can be operated in a substantially purely transmissive state (see the left illustration of FIG. 4), a substantially purely reflective state (see the right illustration of FIG. 4), and an intermediate state, i.e., transreflective (see the middle illustration of FIG. 4). The degree of reflection and transmission can be adjusted electronically. This technology is generally known. The degree of absorption in both transmission and reflection is so small that it can be ignored in this respect.

New in the context of the invention is the use of such an LC mirror layer 26 for local dimming of the pixels of an LCD. According to the invention, the local dimming of the transilluminance with which the pixels of an LCD are transilluminated is performed using the transreflective LC mirror layer 26. For this purpose, the LC mirror layer 26 is divided into individual surface area, the so-called segments 28. The transreflective LC mirror layer 26 can now be controlled on a segment-by-segment basis so that the degree of reflection or transmission can be adjusted differently on a segment-by-segment basis.

FIG. 2 shows a possible structure of the backlighting unit 20, which comprises a reflector array 30 of individual reflectors 32, each reflector being assigned one or more light sources 34. In this exemplary embodiment, the light sources 34 are designed as LEDs or laser diodes and are located on a circuit board 36, for example. On this circuit board 36 is the reflector array 30, above which is typically a diffuser 38 for light equalization (light homogenization). The transreflective LC mirror layer 26 is then arranged above said diffuser 38.

An advantage of the device according to the invention will be explained below with reference to FIG. 2. It is assumed that of the four segments 28 assigned to a reflector 32 in this exemplary embodiment, one segment is to provide dimming of the transillumination of the pixels of the LCD 14 assigned to said segment. This segment is shown hatched in FIG. 2. The light from the light source 34 hitting this segment is now reflected more than the light hitting the other segments associated to the reflector 32. The reflected light is reflected back through the reflector 32 to the less dimmed segments or to the segments that are not dimmed at all, contributing to an increase in the strength of the light that transilluminates the pixels assigned to said segments. This increase in luminous intensity in turn leads to an increased contrast by increasing the “luminous efficiency” of the pixels that require less or no dimming. Overall, the invention can enhance the contrast effect, i.e., the visual light-dark appearance, which in turn means that an increased level of contrast can be achieved by local dimming with less energy input.

### LIST OF REFERENCE NUMERALS

10 device
12 display unit
14 LCD
16 front side
18 display surface
20 backlighting unit
22 rear side of display unit
24 controllable transreflective layer
26 LC reflective layer
28 segments
30 reflector array
32 reflectors
34 light source
36 circuit board
38 diffuser

1. A device for displaying information, comprising
a display unit having a plurality of pixels,
the display unit having a front side forming the display surface for displaying information and a rear side facing away from the front side,
a backlighting unit for emitting backlight towards the rear side of the display unit for backlighting the same, and
an adjustable transreflective layer between the backlighting unit and the display unit for transmitting backlight to backlight the display unit and/or for reflecting backlight to the backlighting unit,
the adjustable transreflective layer having an array of segments, each of which is controllable by means of an electric control signal to adjust the degree of transmission and/or reflection and is thus dimmable, and
wherein the contrast of information shown on the display surface (44) can be adjusted by dimming, as a result of controlling the segments of, those pixels of the display unit which are arranged in alignment with the segment or segments concerned and are assigned to the same.

2. The device according to claim 1, wherein the controllable transreflective layer has a liquid crystal mirror layer or an electrochromic or electrochemical mirror layer.

3. The device according to claim 1, wherein the backlighting unit comprises an array of reflectors and a plurality of light sources, wherein at least one light source is assigned to each reflector, and wherein at least one segment of the adjustable transreflective layer and preferably more than one segment, for example two to ten segments of the adjustable transreflective layer are arranged in alignment with each reflector.

4. The device according to claim 1, wherein the backlighting unit comprises a plurality of light sources and a light guide plate having two main surfaces and a side surface therebetween, one of the two main surfaces facing the back of the display unit and being provided for emitting light entering the light sources from the side surface or light entering the light sources from the other main surface.

5. The device according to claim 1, wherein the light sources are designed as LEDs or laser diodes.

6. The device according to claim 1, further comprising a touch panel for touch sensitivity assigned to the display surface, or a touch panel that is part of the display unit and is provided for assigning touch sensitivity to the display surface.

7. The device according to claim 1, wherein the display unit is designed as an LCD display unit.
